(19) United States
(12) Patent Application Publication
(10) Pub. No.: US 2023/0309464 A1
(43) Pub. Date: Oct. 5, 2023

(54) METHOD AND APPARATUS FOR AUTOMATED CROP RECIPE OPTIMIZATION

(71) Applicant: PANASONIC FACTORY SOLUTIONS ASIA PACIFIC PTE. LTD., Singapore (SG)

(72) Inventors: Song Jin CHNG, Singapore (SG); Akileshwaran UTHAYAKUMAR, Singapore (SG); Jing BAI, Singapore (SG); Cheng Yang, Nicholas THAM, Singapore (SG); Mun Ji LOW, Singapore (SG)

(21) Appl. No.: 18/191,241

(22) Filed: Mar. 28, 2023

Related U.S. Application Data
(60) Provisional application No. 63/326,044, filed on Mar. 31, 2022.

(51) Int. Cl. A01G 9/24; G06T 7/00; G06T 3/00

(52) U.S. Cl. CPC A01G 9/24; G06T 7/0016; G06T 3/0018; G06T 2207/20081; G06T 2207/30188

(57) ABSTRACT

A crop recipe optimization method includes placing crops in an incubator, taking a plurality of images of the crops for measuring crop growth, obtaining a growth score from the plurality of images of the crop, generating, based on the obtained growth score and yield information of the crops, an optimized crop recipe from an artificial intelligence (AI) algorithm, and applying the optimized crop recipe to growing crops in a farm. The plurality of images are associated with one or more crop recipes, and each of the one or more crop recipes represents a set of environmental parameters inside the incubator.

### CROSS-REFERENCE TO RELATED APPLICATION

This application claims the benefit of Provisional Application No. 63/326,044, filed on Mar. 31, 2022, the content of which is incorporated herein by reference in its entirety.

### TECHNICAL FIELD

The present disclosure relates to the field of indoor farming, and in particular relates to a method and an apparatus for automated crop recipe optimization.

### BACKGROUND

In the indoor farming industry, optimization of crop yields and health usually requires significant amounts of resources. Many different environmental and other parameters can greatly affect plant growth. However, it can be challenging and time-consuming to identify how each crop is affected by different parameters. Each crop may require its own recipe. It can be difficult to optimize a wide variety of crops efficiently. Therefore, an automated, self-optimization method to efficiently determine crop recipes is promising for indoor farming.

### SUMMARY

According to one aspect of the present disclosure, a crop recipe optimization method is provided. The method includes placing crops in an incubator, taking a plurality of images of the crop for measuring crop growth, determining the crop growth by obtaining a growth score of the crops from the plurality of images of the crops, generating, based on the obtained growth score and yield information of the crops, an optimized crop recipe from an artificial intelligence (AI)-algorithm, and applying the optimized crop recipe to growing crops in a farm. The plurality of images are associated with one or more crop recipes, and each of the one or more crop recipes represents a set of environmental parameters inside the incubator.

According to another aspect of the present disclosure, an apparatus for automated crop recipe optimization is provided. The apparatus includes two or more incubators for growing crops, at least one dosing system disposed between the two or more incubators and connected with the two or more incubators, and a control system for monitoring growth of the crops and collecting data representing the growth of the crops.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to limit the scope, the embodiments will be described and explained with additional specificity and detail through the use of the drawings below.

FIG. 1 is a schematic diagram illustrating (a) an incubator for preparing crop samples with different recipes; and (b) image processing for different recipes prepared in the incubator according to some embodiments of the present disclosure;

FIG. 2 is a flowchart illustrating an overall process of determining an optimized recipe from AI and applying the optimized recipe to farm according to some embodiments of the present disclosure;

FIG. 3 is a schematic diagram illustrating image processing for calculating crop yields according to some embodiments of the present disclosure;

FIG. 4 is a schematic diagram illustrating comparison results of crop growth using the obtained optimized crop recipe as opposed to using farm recipe according to some embodiments of the present disclosure;

FIG. 5 is a schematic diagram showing correlations between crop recipe optimization in highly controlled incubator environment and AI crop optimization model according to some embodiments of the present disclosure;

FIG. 6 is a schematic diagram illustrating automated crop optimization flow according to some embodiments of the present disclosure;

FIG. 7 is a flowchart illustrating the optimization process for one crop according to some embodiments of the present disclosure;

FIG. 8 is a schematic diagram illustrating (a) a front view and (b) an isometric view of smart incubator and automated nutrient dosing system for different environmental parameters according to some embodiments of the present disclosure;

FIG. 9 is a schematic diagram showing (a) a front view and (b) a side view of sensors located in the incubator according to some embodiments of the present disclosure; and

FIG. 10 is a block diagram illustrating a control system of an apparatus for automated crop recipe optimization according to some embodiments of the present disclosure.

### DETAILED DESCRIPTION OF THE EMBODIMENTS

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

The phrase “in some embodiments” that appears in various places throughout this specification refers to the incubator, control system, and apparatus of this disclosure for implementing the automated crop recipe optimization method in the detailed descriptions.

In crop cultivation, there can be many different processes associated with environmental factors. The productivity of plants, especially, e.g., leafy vegetables, the number of leaves that grow can directly contribute to how much vegetable can be sold in a market, can be associated with different environmental parameters and processing parameters. Each of these parameters may affect different plants or different leaves. Each crop requires its own recipe. It can be time-consuming to demonstrate the influence on the crop yield by each of these environmental parameters and processing parameters.

Therefore, a cost-effective solution to generate crop recipe for self-optimization with resource reduction while maximizing crop yield and health is needed.

According to some embodiments of the present disclosure, an automated crop recipe optimization method is provided to solve the critical need for obtaining optimal recipe for certain plants in an efficient manner.

According to the embodiments of the present disclosure, crop recipes may be obtained from image processing and then the obtained recipes may be optimized using artificial intelligence (AI) in precisely controlled incubator environment. A crop recipe refers to set of environmental parameters that demonstrate the environment for growing crops. For example, a crop recipe may be demonstrated by one or more of the relative humidity (RH), temperature (T), carbon dioxide (CO₂), airflow, medium electrical conductivity (EC), medium pH, light intensity, photoperiod, nutrient, etc. In one instance, a crop recipe may be (T₁, RH₁, pH₁), or (T₂, RH₂, pH₂), where T₁ is different from T₂, RH₁ is different from RH₂, and pH₁ is different from pH₂. The incubator is a highly controlled environment with the above environmental parameters. The nutrients may be determined by the type of the nutrients, or the amount of the nutrients. Each recipe may represent a set of environmental parameters selected from the above. The number of comparable samples or the number of repetitions of each recipe depends on the space to occupy in the incubator and the environmental parameters for consideration.

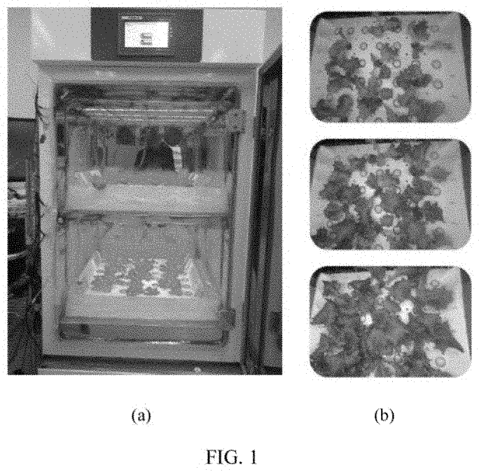

The automated self-optimization method may be implemented by controlling a combination of different environmental parameters. FIG. 1 is a schematic diagram illustrating (a) an incubator for preparing crop samples with different recipes; and (b) image processing for different recipes prepared in the incubator according to some embodiments of the present disclosure. According to some embodiments of the present disclosure, as shown in FIG. 1(a), an incubator 10 may be operated by a control system 11.

Step 101: Placing a plurality of crop samples having different recipes into the incubator for growth, the plurality of crop samples corresponding to a plurality of crop recipes.

In step 101, a plurality of crop samples having different recipes are placed into the incubator. Each crop sample may have a recipe different from the others. As discussed, each crop recipe may represent a set of environmental parameters such as one or more of: relative humidity (RH), temperature (T), carbon dioxide (CO₂), airflow, medium electrical conductivity (EC), medium pH, light intensity, photoperiod, and nutrient, etc. For instance, nine crop samples with nine different crop recipes may be placed into the incubator for growth. Each of the nine crop recipes are different from the others, and each of the nine crop recipes may represent a set of parameters selected from RH, T, CO₂, airflow, medium EC, medium pH, light intensity, photoperiod, nutrient, etc.

Step 102: Monitoring growth of the plurality of crop samples within a preset duration of time.

In step 102, the growth of the plurality of crop samples are monitored in the incubator. The monitoring of the growth of the plurality of crop samples may be taken for a short period of time, for example, a preset duration of time. In one instance, nine crop samples having nine different recipes may correspond to nine experiments conducted in the incubator. As such, growth corresponding to nine crop recipes can be monitored in the incubator within only a short amount of time. For example, as shown in FIG. 1 (b), for lettuce leaves, images may be taken in nine different groups, and the nine group samples all grow in the incubator at different times.

Step 103: Applying the plurality of crop recipes to a written algorithm to determine the optimized recipe for growing the crops in the farm.

In step 103, the nine recipes are taken and fit into a written algorithm, such that a best recipe for growing crops in the farm can be determined. According to some embodiments of the present disclosure, for each crop, a reference that represent farm grown crop may be needed for comparison. By using AI crop image recognition to automatically monitor and calculate crop growth, an AI crop optimization model can be developed to link crop growth and yield directly with any of the above-mentioned environmental parameters.

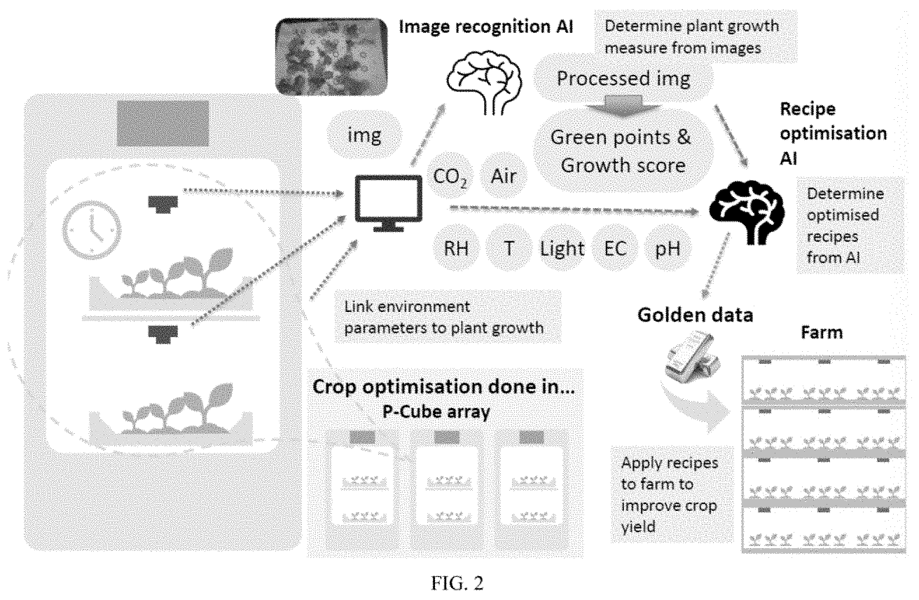

FIG. 2 is a flowchart illustrating an overall process of determining an optimized recipe from AI and applying the optimized recipe to farm according to some embodiments of the present disclosure. As shown in FIG. 2, a plurality of the images of the crop may be taken. For example, a fish-eye camera may be used to take images of the crop. The images may be then used for measuring different factors associated with crop growth, for example, the number of the leaves, the total area covered by the leaves, etc. All the information may then be fed into the written algorithm to determine the growth of the crop. Images of the crop may be taken at every preset duration, for example, every one hour. For each one of these images, features such as the number of leaves, or the area covered by the leaves, may be tracked and processed. The obtained features are then consolidated into a growth score that represents the growth of the plant. Accordingly, through the image recognition and photo processing, the growth score for certain crop can be determined. The process of determining an optimized recipe from AI and applying the optimized recipe to farm is as follows:

Step 201: Determining crop growth measurements from a plurality of images of the crop.

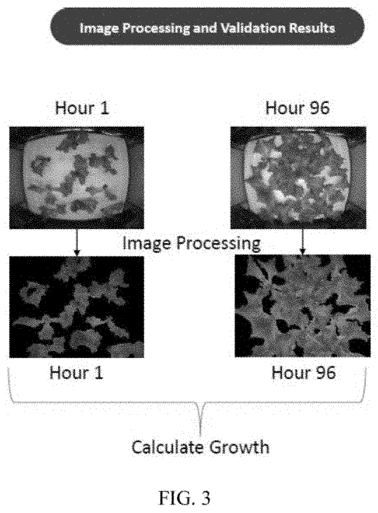

In step 201, crop growth measurement is performed to calculate growth of the crop. FIG. 3 is a schematic diagram illustrating image processing for calculating crop yields according to some embodiments of the present disclosure. As shown in FIG. 3, the plurality of images of the crop may be processed for comparisons. The image may be taken, for example, every 1 hour, up to, for example, 96 hours. The fish-eye camera may cause distortion of the images, and hence an un-distortion matrix may be applied to remove the distortion of the images. During image processing, distortion of the images can be removed to make the image flat. The green area that represents leaves can be then captured. This process may be repeated and the image processing algorithm may be applied on the images captured during the experiment to obtain the growth score of the crop.

Step 202: Determining optimized recipes from artificial intelligence (AI).

In step 202, the optimized recipe can be determined from AI. As discussed in step 103, the plurality of crop recipes can be applied to a written algorithm to determine the golden data, that is, the optimized recipe for growing the crops in the farm. As shown in FIG. 2, validation of the experiment results can be performed using the written algorithm. In some embodiments, the optimized recipe for the crop depends on the type of the crop.

Step 203: Linking environment parameters to crop growth.

In step 203, the environmental parameters such as RH, T, CO₂, airflow, medium EC, medium pH, light intensity, photoperiod, nutrient, etc., may be linked to the growth of the crop based on the optimized recipe and comparisons with other recipes.

Step 204: Applying the optimized recipes to improve crop yield.

In step 204, in some embodiments, the obtained optimized crop recipe can be applied to farm such that the crop yield for the crop that grows in the farm can be improved. As such the farm may be rearranged or inputs changed based on the above method.

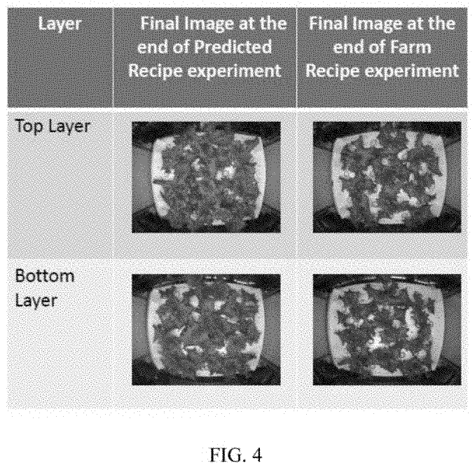

In some other embodiments, the obtained optimized crop recipe can also be applied in incubator again. In some embodiments, the optimized crop recipe for growing crops in farm can also be compared with the farm recipe that is implemented in incubator. FIG. 4 is a schematic diagram illustrating comparison results of crop growth using the obtained optimized crop recipe as opposed to using farm recipe according to some embodiments of the present disclosure. As shown in FIG. 4, the left column shows final images of the lettuce leaves taken when the leaves grow using the optimized recipe. In contrast, the right column shows final images of the lettuce leaves taken when the leaves grow using farm recipe. Both experiments are completed in incubators. From the images in FIG. 4, the productivity of the leaves using the optimized recipe is higher than the productivity of the leaves using the farm recipe, when leaves grow in incubator. Accordingly, the growth score using farm recipe is lower than the growth score using the optimized recipe.

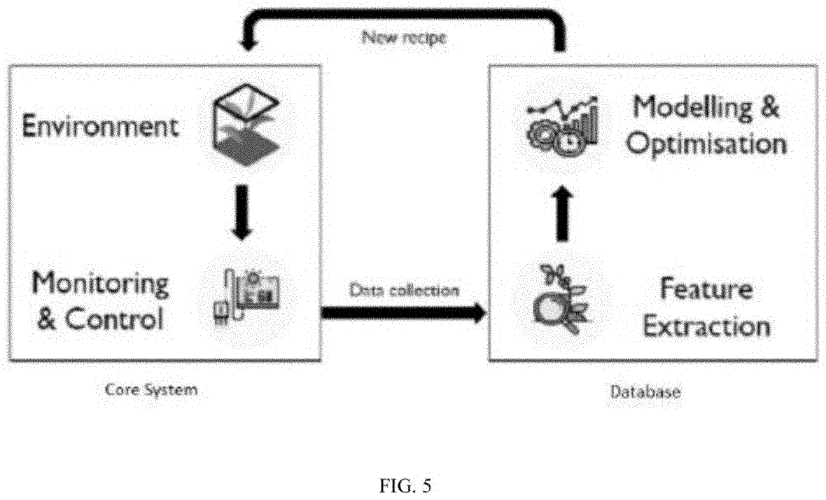

FIG. 5 is a schematic diagram showing correlations between crop recipe optimization in highly controlled incubator environment and AI crop optimization model according to some embodiments of the present disclosure. As shown in FIG. 5, the crop grows in incubator 10, and the growth of the crops may be monitored and controlled by the control system 11 to obtain the data representing the growth of the crop. Feature extraction may be applied to the collected data to obtain the crop optimization model. The optimized recipe can be obtained by using the crop optimization model. Once the optimized recipe is obtained, as discussed in step 204, it may be applied to the crop for growing in incubator to validate the crop optimization model.

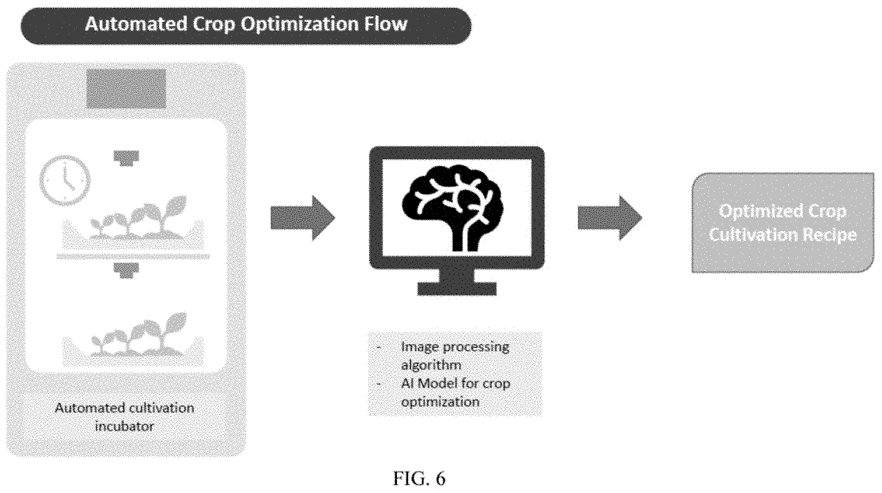

FIG. 6 is a schematic diagram illustrating automated crop optimization flow according to some embodiments of the present disclosure. As shown in FIG. 6, for a specific type of crop, the first level of algorithm is to choose the plurality of environmental parameters and convert the search base of the parameters. For example, the plurality of environmental parameters may include temperature (T) and relative humidity (RH). In some embodiments, the temperature may be 21° C., 22° C., or 25° C., and the corresponding RH may be 55%, 60%, or 65%. The plurality of environmental parameters may be combined for a search base for machine learning model. When more parameters are added to the search base, more levels for algorithms are added, which increases the range of the search base. During the first level of the algorithm, a minimum number of the crop recipes may be selected. The minimum number of crop recipes may be initial sets of parameters. Then the experiments may be completed in the incubator. The growth of the crop may be captured and converted into a growth score. The environmental parameters and the growth score are used to obtain the AI model for crop optimization, such that the optimized crop recipe can be obtained.

In the first step, the machine learning model is built with the initialized recipes. After the machine learning model is built, two to three additional recipes may be used to check the accuracy of the model. The prediction results of the machine learning model are expected to follow the trend of the actual growth score of the crop from the experiments. More recipes may be explored to improve the prediction capability of the machine learning model.

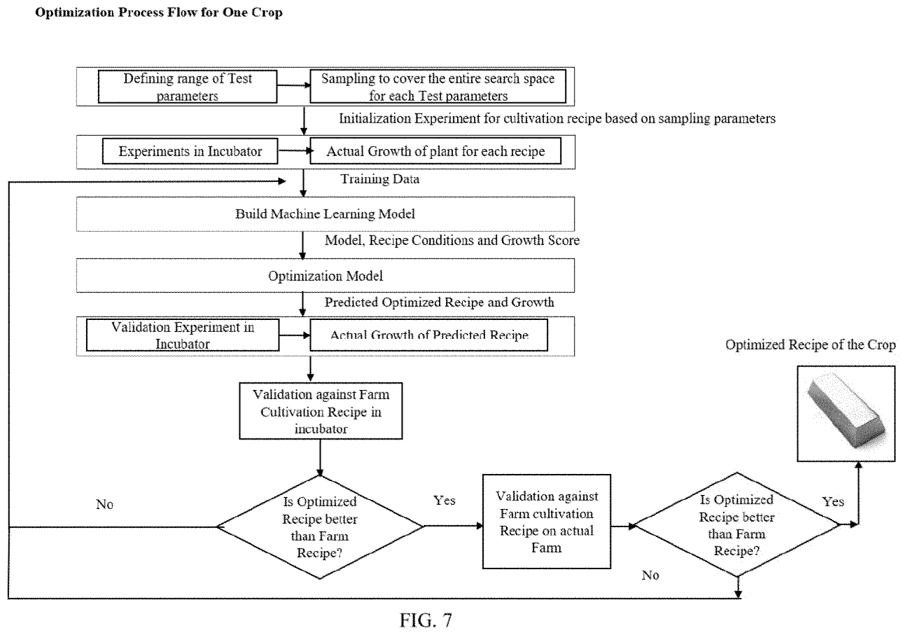

Then the plurality of images may be taken to obtain the growth score, and the optimization model can be obtained by feeding the plurality of crop recipes and the growth score to the machine learning model. FIG. 7 is a flowchart illustrating the optimization process for one crop according to some embodiments of the present disclosure. According to some embodiments of the present disclosure. As shown in FIG. 7, a range of the plurality of environmental parameters may be defined. Data sampling may then be performed to cover the entire search space of the range of the environmental parameters. As the experiment implementing initial crop recipes proceeds in the incubator, the actual growth of the crop may be measured for each crop recipe. For example, during a 4-day period of experiment, the images of the crop may be taken periodically to obtain growth scores, and training data from the search space may be used for training the machine learning model. Afterward, crop recipes that represent the environmental parameters and corresponding growth scores can be fed to the machine learning model. As such, the crop optimization model for predicting optimized crop recipe and growth can be obtained.

The second step is the validation, that is, compare the optimized crop recipe with the standard farm recipe. Farm conditions can be replicated in the incubator. It can be time-efficient to replicate farm conditions in the incubator.

Specifically, the optimized crop recipe may be used to prepare a crop sample, and grow the crop sample in the incubator, for a preset duration of time, e.g., 4 days. The actual growth of the crop using the optimized recipe may be recorded. Then the actual growth of the crop using the optimized recipe is compared with the crop using the farm recipe. Both experiments are completed in the incubator. If the result shows that the yield of optimized recipe is higher than the farm recipe, then the crop optimization model may be further validated. Another extended period of validation may be further performed. For example, another group of experiments in comparison may be performed for a 14-day growth period. If the yield of optimized recipe is higher than the farm recipe, then the crop optimization model is validated. The crop optimization model after validation can be used to predict optimized crop recipe. Whether during the short period of validation, for example, the 4-day period, or during the extended period of validation, for example, the 14-day period, if the yield of the predicted optimized recipe is less than the farm recipe, the machine learning model must be trained again with more training data.

According to the embodiments of the present disclosure, after the optimized crop recipe is determined, more experiments with the optimized crop recipe can be implemented in the actual farm.

In some embodiments, the data for data sampling may include an entire set of environmental parameters in the defined range. For example, for the entire set, there can be 4,000 data samples. A minimum number of the data samples may be selected. The environmental parameters corresponding to the minimum number of data can cover the search space as much as possible. For the same environmental parameter, each recipe may have entirely different values from the others.

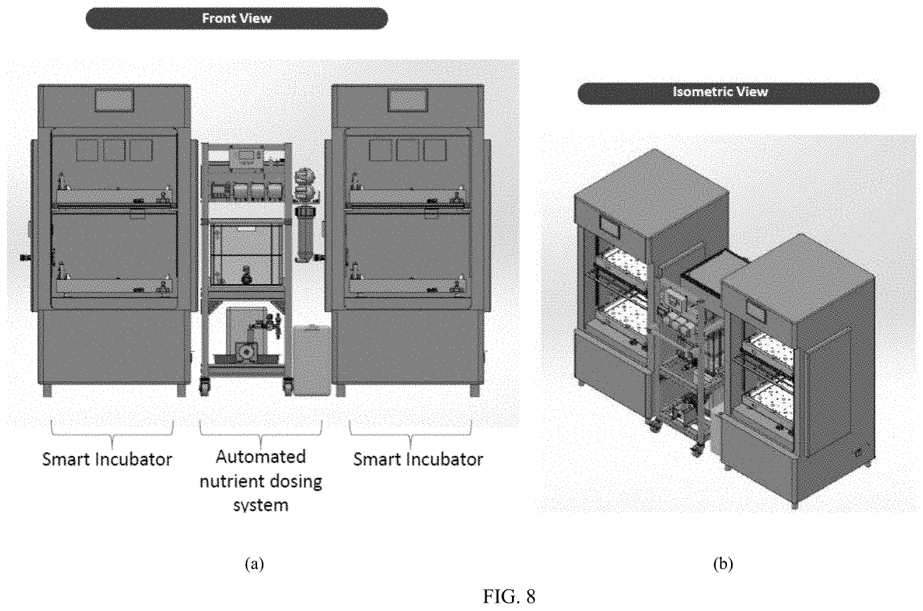

According to some embodiments of the present disclosure, an apparatus for automated crop recipe optimization is also provided. FIG. 8 is a schematic diagram illustrating (a) a front view and (b) an isometric view of smart incubator and automated nutrient dosing system for different environmental parameters according to some embodiments of the present disclosure. As shown in FIG. 8, the apparatus for automated crop recipe optimization may include two incubators 10 connected through a dosing system 12. The dosing system 12 is configured to introduce nutrients and water to the incubators 10. A meter 13 may be disposed at the bottom of the dosing system. A panel 14 may be disposed at a top of the dosing system. The panel 14 may include the control system 11 for the apparatus for automated crop recipe optimization. The middle part of the dosing system 12 is configured for introducing water and nutrients to the apparatus. A pump 15 may also be disposed at the bottom of the dosing system for providing air pressure needed for introducing water and nutrients into the incubator. Each incubator 10 may contain one only crop recipe under experiment. The same system may also be used to optimize seeding or germination.

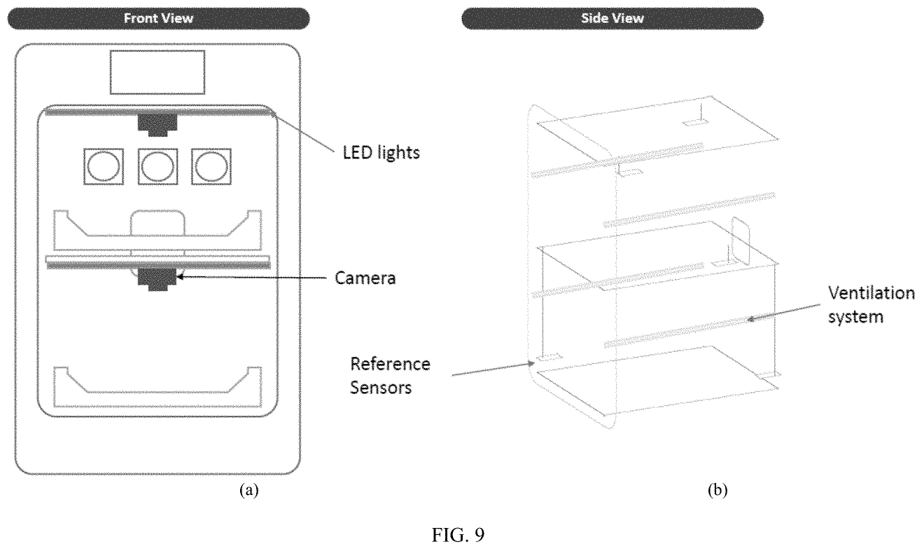

The growth of crop may be recorded when the crop grows in the incubator. FIG. 9 is a schematic diagram showing (a) a front view and (b) a side view of sensors located in the incubator according to some embodiments of the present disclosure. As shown in FIG. 9(a), an light-emitting diode (LED) light 16 may be disposed under a top rack of the incubator 10, and a camera 17 may be disposed under a middle rack of the incubator 10. In FIG. 9(b), a plurality of reference sensors 18 may be disposed at different locations inside the incubator 10, and a plurality of ventilation systems 19 may also be disposed at different locations inside the incubator 10. The reference sensors 18 are configured for precise environmental data collection. The reference sensors 18 may collected environmental data periodically, for example, every one hour, and process the sample with data, e.g., image data, to get a growth score to train the machine learning model for obtaining the optimized recipe.

The incubator 10 is a multi-layer fully automated crop cultivation incubator suitable for different cultivation methods, for example, deep water culture, nutrient film technique, and soil planting, etc. Indoor farming may involve different technologies, such as aeroponic, hydroponic, or soil-based methods. The incubator 10 provided by the embodiments of the present disclosure may implement different farming technologies inside the system.

In some embodiments, the incubator 10 may be suitable for growing multiple crops all at the same time. The light intensity may be controlled according to a daily schedule such that through the panel 14 may select desired light intensity and enable automated scheduling for desired lighting duration. Through the dosing system 12, environmental parameters such as the medium electrical conductivity (EC) or pH for a hydroponic system may be controlled, such that automated nutrient preparation for desired concentration or combination or maintaining nutrient concentration at desired level may be implemented. Air flow control for uniform distribution may also be achieved in the incubator 10. The control system 11 may be a centralized control system, and the panel 14 may be in communication with the control system 11 via, e.g., LAN based network. Multiple incubators may be all controlled together by the control system 11. The control system 11 may include a user interface for setting up environmental parameters for crop growth.

According to the embodiments of the present disclosure, the apparatus for automated crop optimization may further include a web application (i.e., frontend and backend) to conduct optimization and validation experiments and control parameters of incubators. A microcontroller programing system/minicomputer programming system is configured to control CO₂, dosing and lighting systems, to control camera, dosing system and coordinate with backend to implement recipe, an incubator hardware and software system configured to maintain and control the environmental parameters, an image processing algorithm to capture and quantify growth details of the plants, a ventilation system configured to achieve uniformity of air distribution inside the incubator, and a dosing control and nutrient circulation system configured to maintain nutrient level on cultivation trays.

Therefore, with a combination of developed incubator systems with highly controlled environments (e.g., RH, T, CO₂, airflow, light, EC, pH, etc.) and crop imaging system with an AI crop recognition and optimization engine, rapid automated crop recipe optimization can be achieved. A minimal number of algorithm-determined recipes with different parameter sets can be first automatically determined. Crops may then grow in the precisely controlled environment of the developed incubator systems. Growth information and yield information may be automatically collected via AI crop recognition. The growth information may then be used to train an AI crop recipe optimization engine, which can subsequently predict an optimized crop recipe for us in farms. The same optimized recipe can also be validated in the incubator system, providing a full closed-loop solution for crop optimization.

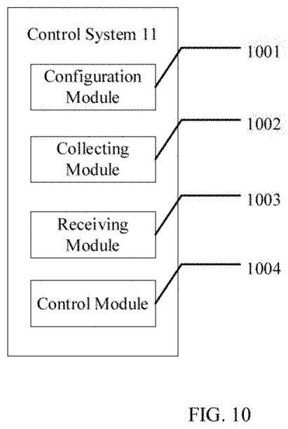

FIG. 10 is a block diagram illustrating a control system of an apparatus for automated crop recipe optimization according to some embodiments of the present disclosure.

In some embodiments, the control system 11 may also include a plurality of modules. The plurality of modules may include: a configuration module 1001 configured to set up environmental parameters inside the incubator 10; a collecting module 1002 configured to collect environmental data from each of the plurality of reference sensors 18; a receiving module 1003 configured to receive an instruction from a server remotely communicated with the control system 11; and a control module 1004 configured to be connected to a device inside the incubator for adjusting the corresponding parameter inside the incubator.

As shown in FIG. 10, the control system 11 may include a configuration module 1001, a collecting module 1002, a receiving module 1003, and a control module 1004.

The configuration module 1001 may be configured to set initial environmental parameters inside the incubator 10. The configuration module 1001 may be further configured to set parameters for crop growth corresponding to a condition inside the incubator 10. The collecting module 1002 may be configured to collect environmental data from the plurality of reference sensors 18. The data indicates parameters detected by the plurality of reference sensors 18. The receiving module 1003 may be configured to receive an instruction from a server remotely communicated with the control system 11. Upon receiving the instruction from the server, the control module 1004 may be configured to adjust a parameter associated with the environment inside the incubator 10. The control module 1004 may control a device located inside the incubator 10 to adjust the environmental parameter.

A person skilled in the art should recognize, however, that the embodiments of the present disclosure may also be implemented in a computer program product disposed upon a computer-readable storage medium having computer readable program instructions for causing the server to carry out the foregoing described method.

The computer-readable storage medium can be a tangible device for storing instructions. The computer-readable storage medium includes flash drive, movable hard disks, read-only memory (ROM), random-access memory (RAM), magnetic disks or optical disks, and other mediums that can store program codes.

Computer-readable program instructions described herein can be downloaded to respective computing/processing devices from the computer-readable storage medium or to an external computer or external storage device via a network, for example, the Internet, a LAN, a WAN, or a wireless network.

Computer-readable program instructions for carrying out the method embodiment of the present disclosure may be assembler instructions, instruction-set architecture (ISA) instructions, machine instructions, machine dependent instructions, microcode, firmware instructions, state-setting data, or other source code or object code written in any combination of one or more programming languages.

The computer-readable program instructions may execute entirely on a mobile terminal, partly on the mobile terminal, as a standalone software package, partly on the mobile terminal and partly on the server or entirely on the server.

The above description of the disclosed embodiments of the present disclosure can enable those skilled in the art to implement or use the present disclosure. Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A crop recipe optimization method, comprising:
placing crops in an incubator;
taking a plurality of images of the crops for measuring crop growth, the plurality of images being associated with one or more crop recipes, each of the one or more crop recipes representing a set of environmental parameters inside the incubator;
obtaining a growth score of the crops from the plurality of images of the crops;
generating, based on the obtained growth score and yield information of the crops, an optimized crop recipe from an artificial intelligence (AI)-algorithm; and
applying the optimized crop recipe to growing crops in a farm.

2. The method according to claim 1, wherein the algorithm is a trained machine learning model by artificial intelligence (AI).

3. The method according to claim 1, further comprising:
processing the plurality of images for training a machine learning model to obtain the AI-algorithm; and
determining the AI-algorithm to be a crop recipe optimization model for predicting crop recipes.

4. The method according to claim 1, wherein the incubator comprises one or more of a temperature sensor, a humidity sensor, a light-emitting diode (LED) light, an optical sensor, a camera, a gas sensor, an electrical conductivity (EC) sensor, and a pH sensor.

5. The method according to claim 4, wherein:
each of the one or more of the temperature sensor, humidity sensor, light-emitting diode (LED) light, optical sensor, camera, gas sensor, EC sensor, and pH sensor is configured to detect a corresponding environmental parameter inside the incubator; and
the set of environmental parameters comprise one or more of relative humidity (RH), temperature (T), concentration of carbon dioxide (CO₂), airflow, light, soil electrical conductivity (EC), and pH.

6. The method according to claim 3, wherein feature extraction is performed to process the plurality of the images and obtain data for training the machine learning model.

7. The method according to claim 3, further comprising:
predicting growth scores for a number of crop recipes for validation;
for each of the number of recipes for validation, comparing the predicted growth score with actual growth of crop in incubator;
in response to each predicted growth score corresponding to actual growth of crop in incubator, determining the AI-algorithm to be the crop recipe optimization model for predicting crop recipes.

8. The method according to claim 3, further comprising:
applying the optimized crop recipe to grow crop in the incubator;
comparing growth of a first crop sample using the optimized crop recipe with growth of a second crop using a farm recipe; and
in response to the first crop sample yielding more crop than the second crop sample, determining that the crop optimization model is validated.

9. The method according to claim 3, wherein processing the plurality of images comprises:
removing distortion of the plurality of images to make the plurality of images flat.

10. The method according to claim 1, wherein the plurality of images are taken in a preset duration of time.

11. The method according to claim 10, wherein the preset duration of time is 1 hour.

12. An apparatus for automated crop recipe optimization, comprising:
two or more incubators for growing crops;
at least one dosing system disposed between the two or more incubators and connected with the two or more incubators; and
a control system for monitoring growth of the crops and collecting data representing the growth of the crops.

13. The apparatus according to claim 12, wherein each of the two or more incubators is a multi-layer incubator capable of performing multiple experiments at the same time.

14. The apparatus according to claim 12, wherein the at least one dosing system comprises a pump and a meter disposed at a bottom of the at least one dosing system and a panel disposed at a top of the at least one dosing system.

15. The apparatus according to claim 14, wherein the pump is configured to introduce water and nutrients into the at least one dosing system.

16. The apparatus according to claim 12, wherein each of the two or more incubators comprises one or more of: a temperature sensor, a humidity sensor, a light-emitting diode (LED) light, an optical sensor, a camera, a gas sensor, an electrical conductivity (EC) sensor, and a pH sensor.

17. The apparatus according to claim 12, wherein the control system comprises:
a configuration module configured to set up environmental parameters inside the incubator;
a collecting module configured to collect environmental data from each of a plurality of sensors disposed inside the incubator;
a receiving module configured to receive an instruction from a server remotely communicated with the control system; and
a control module configured to be connected to a device inside the incubator for adjusting the corresponding parameter inside the incubator.

18. A crop recipe optimization method, comprising:
initializing a first number of crop recipes, the first number of crop recipes being different from each other;
applying the initialized first number of crop recipes to train a machine learning model;
predicting growth scores for a second number of crop recipes for validation;
for each of the second number of crop recipes for validation, comparing the predicted growth score with corresponding actual growth of the crop in an incubator; and
in response to each of the predicted growth scores corresponding to actual growth of the crop in the incubator, determining the trained machine learning model to be a crop recipe optimization model for obtaining optimized crop recipes.

19. The method according to claim 18, wherein initializing the first number of crop recipes comprises:
placing the first number of crops in an incubator; and
taking a plurality of images for the first number of the crops for measuring crop growth, each of the first number of crop recipes corresponding to a set of environmental parameters inside the incubator.
